(19) United States
(12) Patent Application Publication
(10) Pub. No.: US 2025/0347800 A1
(43) Pub. Date: Nov. 13, 2025

(54) DEVICE AND METHOD FOR TRACKING OBJECT USING CENTER POINT OF TRACK

(71) Applicant: HL KLEMOVE CORPORATION, Incheon (KR)

(72) Inventor: Yong Hyeon CHO, Incheon (KR)

(21) Appl. No.: 18/917,245

(22) Filed: Oct. 16, 2024

(30) Foreign Application Priority Data
May 10, 2024 (KR) 10-2024-0061632

(51) Int. Cl. G01S 13/72; G01S 13/931

(52) U.S. Cl. CPC G01S 13/723; G01S 13/931

(57) ABSTRACT

The disclosure relates to a technology for tracking an object using a center point of a track and provides an object tracking device and method, comprising receiving location information about detection points for an object and setting a first track of the object and a second track extended from the first track based on the location information, determining the number of crossing points between a line connecting the detection point and the radar and any one of the first track or the second track based on movement information about a first track center point, and resetting the first track and the second track based on location information about a detection point in which the number of crossing points is less than N as preset (where N is an integer of two or more) and tracking the object based on any one of the reset first track or second track.

### CROSS-REFERENCE TO RELATED APPLICATION

This application claims priority from Korean Patent Application No. 10-2024-0061632, filed on May 10, 2024, which is hereby incorporated by reference for all purposes as if fully set forth herein.

### BACKGROUND

### Technical Field

The disclosure relates to a technique for tracking an object using a center point of a track.

### Description of Related Art

Advanced driver assistance system (ADAS), one of the modern state-of-the-art driving assistance systems, and autonomous driving are in the spotlight as functions for safe and convenient driving of drivers.

ADAS refers to a system for braking a driving vehicle or warning the driver based on information detected through various sensors. ADAS may include functions such as adaptive cruise control (ACC), autonomous emergency braking (AEB), forward collision avoidance assist (FCA), lane departure warning system (LDWS), lane keeping assist system (LKAS), blind-spot collision warning (BCW), and high beam assist (HBA).

For ADAS and autonomous driving, it is important to perceive the surrounding situation.

Vehicles to which ADAS and autonomous driving are applied need to accurately estimate geometric information such as width, length, and direction angle beyond kinematic information such as the speed of the target vehicle located around the host vehicle. In particular, radar, which is an ADAS-applied sensor, has recently been advanced and developed to detect multiple measurements for inferring the shape of a vehicle.

Conventional radars have been mainly used for military purposes to monitor aircraft or missiles, and are designed to detect the target using a single point. However, the radar designed to detect the target using a single point may not realize various functions of ADAS and ensure safe driving.

Further, the conventional radar-based object tracking may cause ghost detection when tracking an object slowly approaching the host vehicle or when there are many objects around the host vehicle, rendering it difficult to distinguish between the detection point which is supposed to be actually tracked and the ghost detection point. This leads to wrong object estimation.

There are proposed methods for removing ghost detection points through an artificial intelligence model, but these methods suffer from difficulty in training due to diversity of objects around the host vehicle, the need for massive learning data although training is possible, and consumption of excessive time and costs.

### BRIEF SUMMARY

The disclosure provides a technology for tracking an object using a center point of a track.

In an aspect, the present embodiments provide an object tracking device of tracking an object using a center point of a track, comprising a track setter receiving location information about a plurality of detection points for an object from a radar and setting a first track of the object and a second track extended from the first track based on the location information, a crossing point counter determining the number of crossing points between a line connecting the detection point and the radar and any one of the first track or the second track based on movement information about a first track center point, and an object tracker resetting the first track and the second track based on location information about a detection point in which the number of crossing points is less than N as preset (where N is an integer of two or more) and tracking the object based on any one of the reset first track or second track.

In another aspect, the present embodiments provide an object tracking method of tracking an object using a center point of a track, comprising receiving location information about a plurality of detection points for an object from a radar, and setting a first track of the object and a second track extended from the first track based on the location information, determining the number of crossing points between a line connecting the detection point and the radar and any one of the first track or the second track based on movement information about a first track center point, and resetting the first track and the second track based on location information about a detection point in which the number of crossing points is less than N as preset (where N is an integer of two or more) and tracking the object based on any one of the reset first track or second track.

The disclosure may provide a technology for tracking an object using a center point of a track.

### BRIEF DESCRIPTION OF THE SEVERAL VIEWS OF THE DRAWINGS

The above and other objects, features, and advantages of the disclosure will be more clearly understood from the following detailed description, taken in conjunction with the accompanying drawings, in which:

FIG. 1 is a view illustrating a configuration of a device for tracking an object using a center point of a track, according to an embodiment;

FIG. 2 is a view illustrating a detection point detected through a radar according to an embodiment;

FIG. 3 is a view illustrating a track generated with respect to a detection point detected through a radar, according to an embodiment;

FIG. 4 is a view illustrating a determination criterion for detection points detected with a fixed object interposed therebetween, according to an embodiment;

FIG. 5 is a flowchart illustrating a process of tracking an object using a center point of a track, according to an embodiment;

FIG. 6 is a view illustrating a usual-time object tracking method according to an embodiment;

FIG. 7 is a view illustrating an object tracking method in a special situation, according to an embodiment;

FIG. 8 is a flowchart illustrating an example of detecting an object based on a center point of a track, according to an embodiment; and

FIG. 9 is a flowchart illustrating a method for tracking an object using a center point of a track, according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, embodiments are described in detail with reference to the accompanying drawings.

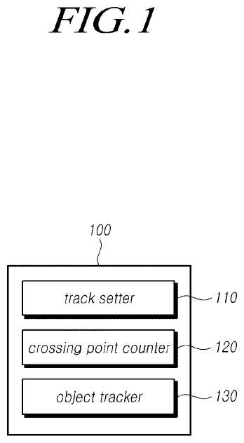

FIG. 1 is a view illustrating a configuration of a device for tracking an object using a center point of a track, according to an embodiment.

Referring to FIG. 1, an object tracking device 100 using a center point of a track includes a track setter 110 for receiving location information about a plurality of detection points for the object from a radar and setting a first track of the object and a second track extended from the first track based on the location information.

By transmitting and receiving a signal through the object, the radar may derive location information including a direction and a distance in which a portion of the object is located based on a speed and a round trip time of the signal. In the disclosure, the portion of the object may be referred to as a detection point. Accordingly, the object tracking device 100 of the disclosure may receive location information about a plurality of detection points for an object from a radar.

The track setter 110, which is a component of the object tracking device 100, may set a first track based on the location information about the detection point received from the radar. The first track may be a two-dimensional figure including all of the received detection points. Alternatively, the first track may be a two-dimensional figure including some of the received detection points.

For example, when the track setter 110 of the disclosure receives three detection points from the radar, the track setter 110 may set the first track including the three detection points. Alternatively, the track setter 110 of the disclosure may set a first track including only two detection points among the three detection points received from the radar.

The shape of the first track may be a symmetrical figure such as of a triangle, a square, a circle, or an ellipse, or may be an asymmetric figure. Various shapes of the first track may be set as necessary, and the number of detection points is not limited.

The track setter 110, which is a component of the object tracking device 100, may set a second track extended from the first track. For example, when the first track is an ellipse in which ½ of the long axis is 10 cm and ½ of the short axis is 5 cm, the second track may be an ellipse 5 cm longer than each of ½ of the long axis and ½ of the short axis of the first track. Alternatively, the second track may be an ellipse 5 cm longer than ½ of the long axis of the first track and 7 cm larger than ½ of the short axis. However, this is merely an example, and the shape of the second track may not be the same as that of the first track. Various shapes of each track may be set as necessary.

For example, the track setter 110 of the disclosure may set the first track and the second track in an elliptical shape. Since the object tracking device 100 of the disclosure needs to clearly identify the location and shape of another vehicle to avoid collision with the other vehicle attempting to cut in while the host vehicle moves, it is proposed that the first track and the second track have an ellipse which is a shape most similar to that of the vehicle. However, this is merely an example, and various shapes may beset as necessary, such as a circular shape, a square shape, a triangle, etc.

As another example, the track setter 110 of the disclosure may set the first track and the second track based on an algorithm including at least one of a random finite set model, a random matrix model, or an elliptic shape model.

An extended object tracking method according to the disclosure has been developed to compensate for the issues with the conventional object tracking method in of tracking the target with a single point taken as the target, and the extended object tracking method is a method for tracking an object using a plurality of detection points.

For example, the track setter 110 of the disclosure may use an algorithm including at least one of a random finite set model, a random matrix model, or an elliptic shape model in forming a track based on location information about a plurality of detection points. The disclosure proposes to use an algorithm including an elliptic shape model for tracking an object by forming a track having a shape similar to the shape of a vehicle to prevent collision with another vehicle approaching the host vehicle.

The object tracking device 100 using the center point of the track includes a crossing point counter 120 that determines the number of crossing points of the line connecting the detection point and the radar and any one of the first rack or the second track based on movement information about the center point of the first track.

The object tracking device 100 of the disclosure may find and remove a ghost detection point other than the detection point regarding the actual object in the location information about the plurality of detection points received from the radar in order to track the object around the vehicle without an error.

The above-described ghost detection point may refer to a detection point generated due to a radar signal error for an object approaching at a low speed from a location close to the host vehicle, or a detection point generated from another object located around the object.

In the disclosure, the ghost detection point may also be referred to as a ghost.

As a method for removing the ghost detection point, there is proposed a method in which the object tracking device 100 of the disclosure determines the number of crossing points between the line connecting the detection point and the radar and any one of the first track or the second track set by the track setter 110, and if the determined number of crossing points is larger than or equal to a predetermined number, determines and removes the corresponding detection point as a ghost.

Which of the first track or the second track is a reference to determine the number of crossing points may be determined based on the movement information about the first track center point.

For example, the movement information about the first track center point may be determine based on the location information about the detection point, and may include at least one of the location and the moving speed of the first track center point.

As another example, when the location of the first track center point is located outside the set area, the crossing point counter 120 of the disclosure may determine the number of crossing points between the line connecting the detection point and the radar and the first track.

As another example, when the location of the first track center point is located in a set area, the crossing point counter 120 of the disclosure may determine the number of crossing points between the line connecting the detection point and the radar and the second track.

In order to remove the ghost detection point, the object tracking device 100 of the disclosure may determine the number of crossing points between the first track or the second track and the line connecting the radar and the detection point, compare the determined number of crossing points with a predetermined number, determine whether the detection point is a ghost detection point which is a ghost based on the comparison result, and remove the detection point when the corresponding detection point is determined as the ghost detection point.

As another example, the inside of the set area may include at least one of the object tracked by the object tracking device, a static object other than the object, and a dynamic object other than the object, and the moving speed of the dynamic object may be less than a first numerical value.

The ghost detection point to be removed by the object tracking device 100 of the disclosure may be generated when the distance between the host vehicle and the object is short, or an object having a slow moving speed approaches the host vehicle. Accordingly, the object tracking device 100 of the disclosure may set an area including objects with little movement in real time, and when the center point of the first track is located in a predetermined area, set the size of the object to be larger and determine the number of crossing points between the second target extended from the first target and the line connecting the radar and the detection point.

Further, when the center point of the first track is located outside the set area, the object tracking device 100 of the disclosure may determine the number of crossing points between the first track and the line connecting the detection point to the radar.

As another example, when the moving speed of the first track center point is less than a second numerical value, the crossing point counter 120 of the disclosure may determine the number of crossing points between the line connecting the detection point and the radar and the second track.

As another example, when the moving speed of the first track center point is larger than or equal to the second numerical value, the crossing point counter 120 of the disclosure may determine the number of crossing points between the line connecting the detection point and the radar and the first track.

In light that many ghost detection points may be generated when the moving speed of the target is slow, the object tracking device 100 of the disclosure may determine the number of crossing points between the line connecting the detection point and the radar and the second track when the moving speed of the first track center point is less than the set second numerical value, and determine the number of crossing points between the line connecting the detection point and the radar and the first track when the moving speed of the first track center point is larger than or equal to the set second numerical value, thereby removing the ghost detection point.

The object tracking device 100 of the disclosure includes an object tracker 130 resetting a first track and a second track based on location information about detection points where the number of crossing points is less than a preset number, N (where N is an integer larger than or equal to 2), and track an object based on any one of the reset first track or second track.

When the number of crossing points is larger than or equal to the preset number N (where N is an integer larger than or equal to 2), the object tracking device 100 of the disclosure may determine that the corresponding detection point is a ghost detection point irrelevant to the object, and set the first track and the second track again around the remaining detection points after removing the detection point determined as the ghost detection point, thereby tracking the target in real time.

The determination criterion for the ghost detection point may be when the number of crossing points is N or more, or when the number of crossing points is N. As the above-described determination criterion is merely an example, various determination criteria may be set as necessary.

The object tracking device 100 of the disclosure may apply the ADAS function to the vehicle according to the situation and control the corresponding vehicle by determining and removing the detection point determined as the ghost detection point among the detection points received from the radar. Further, the object tracking device 100 of the disclosure may accurately estimate the other vehicle attempting to cut in at a short distance toward the host vehicle, preventing an accident caused by a collision between the host vehicle and another vehicle and accurately perceiving the situation occurring during driving to enable an active response such as collision warning or discharging airbags, thereby enhancing the adaptive cruise control (ACC) performance of the host vehicle.

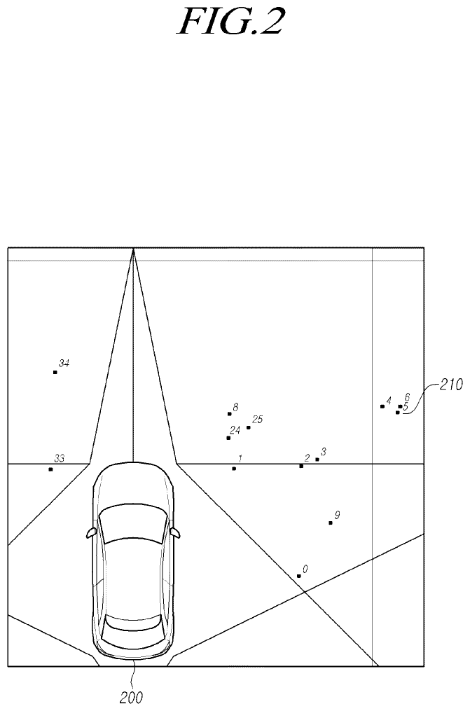

Hereinafter, a process of tracking an object located around a vehicle using a center point of a track is described in detail with reference to FIG. 2.

FIG. 2 is a view illustrating a detection point detected through a radar according to an embodiment.

Referring to FIG. 2, a radar detects a detection point 210 of an object located around the host vehicle 200 through signal transmission/reception. Various information including location information about the detected detection point 210 may be received from the radar by the object tracking device of the disclosure.

Referring to FIG. 2, location information about the detection point 210 may be received through a signal transmitted for at least one object through the radar. The detection point 210 may refer to a location where the transmitted signal is reflected through the object.

The location of the detection point 210 may be determined based on the speed of the transmission from the radar, the direction of the transmission, and the time taken from the transmission to the return. The track may be set based on the location information about the detection point 210, and the location and moving speed of the track center point may be measured.

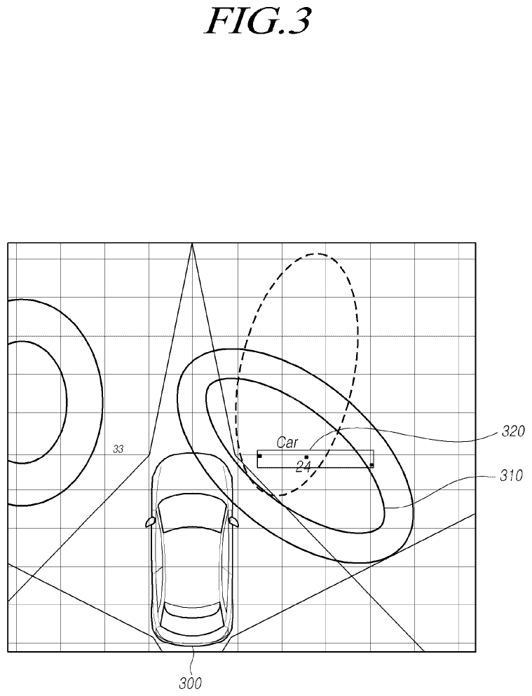

FIG. 3 is a view illustrating a track generated with respect to a detection point detected through a radar, according to an embodiment.

The object tracking device of the disclosure may obtain location information about a plurality of detection points 320 based on signal information fired through the radar. Based on the obtained location information about the detection point 320, a track 310 capable of identifying the location, the moving state, or the like of the object to be tracked may be set.

An image of the object moving through the track 310 may be output through a display device mounted in the vehicle. Accordingly, the driver in the autonomously driving vehicle may directly control the vehicle to prevent collision with the object. The track 310 may be a two-dimensional figure or a three-dimensional figure surrounding the object. In the disclosure, two tracks 310 are proposed, but this is merely an example, and various numbers of tracks may be set as necessary.

Referring to FIG. 3, the object tracking device of the disclosure detects an object located around the host vehicle 300 to obtain location information about the detection point 320 from the radar, and forms two tracks 310 based on the location information about the plurality of detection points 320. In the object tracking device of the disclosure, the shape of the track 310 is an elliptical shape, but the shape of the track is not limited thereto, and various shapes may be set as necessary.

Further, various algorithms may be applied to determine the shape, tracking method, etc. of the track 310 for the object tracking technique through the radar.

For example, a random matrix model may be applied. The random matrix model is a method for obtaining various pieces of detection information from the radar under the assumption of a specific function using the shape of the object as a parameter and estimating the shape of the object which is the precise map defined in the function using the obtained detection information. The random matrix model has the advantage of being simple to implement.

As another example, a random finite set model may be applied. The random finite set model is a model that estimates the shape and movement path of an object by modeling the location and speed information about the object received from the radar as a random finite set.

As another example, an elliptic shape model may be applied. The elliptic shape model is a model that receives location information about each detection point 320 of the object from the radar, forms a plurality of elliptical tracks 310, and tracks the movement of the object based on the information received from the radar.

The disclosure proposes using an elliptic shape model that easily forms an elliptical shape which is a shape most similar to the vehicle as the track 310 and removes the unnecessary ghost detection point among the detection points received from the radar to prevent a collision with the object including another vehicle attempting to cut in at a short distance from the host vehicle 300.

When there is another vehicle attempting to cut in to the host vehicle 300, the detection points 320 received from the radar may include an actual detection point of the object to be tracked and a ghost detection point irrelevant to the object to be tracked.

If object tracking is performed with a track set even considering ghost detection points or after a track is set after even actual detection points are removed by wrong criteria, the host vehicle and the track may be shown as overlapping each other as if a collision occurs between the host vehicle and the other vehicle although it does not really.

Therefore, there is proposed a method in which the object tracking device clearly prevents a collision between the host vehicle and another vehicle by clearly removing ghost detection points and resetting the set tracks based only on actual detection points to track the target.

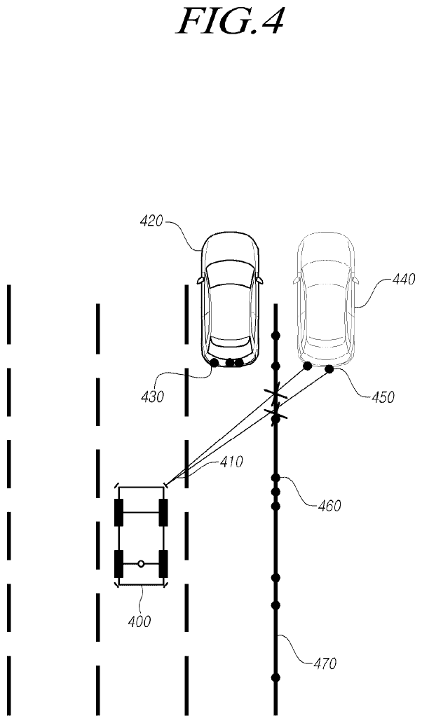

FIG. 4 is a view illustrating a determination criterion for detection points detected with a fixed object interposed therebetween, according to an embodiment.

Referring to FIG. 4, a radar 410 mounted to a host vehicle 400 may transmit information about a detection point 430 to an object tracking device by transmitting and receiving a signal to and from another vehicle 420 moving around the host vehicle 400. However, a signal including information about a ghost detection point 450 may be transmitted to the object tracking device.

The ghost detection point 450 may be one incorrectly detected due to an error of the radar 410, or may be one generated from an object 440 other than the other vehicle 420 to be tracked.

As a method for removing the ghost detection point 450, when there is a crossing point between the line connecting the radar 410 and the detection point and a fixed object such as a guardrail 470, the object tracking device of the disclosure may determine that the detection point 450 is a ghost and, when there is no crossing point, the object tracking device may determine that the detection point 430 is an actual detection point 430, and may set a track based only on the actual detection point 430 to track the object 420.

This method may be utilized when there is another vehicle 440 driving in a direction opposite to the driving direction of the host vehicle 400 with respect to the guardrail, and collision of which with the host vehicle 400 need not be considered, the detection point 450 perceived by the radar 410 should be removed due to the other vehicle 440.

However, this method requires a long fixed object 470 such as a guardrail. Accordingly, there is proposed a method in which the object tracking device of the disclosure tracks an object using a center point of a formed track, rather than based on a fixed object 470 such as a guardrail.

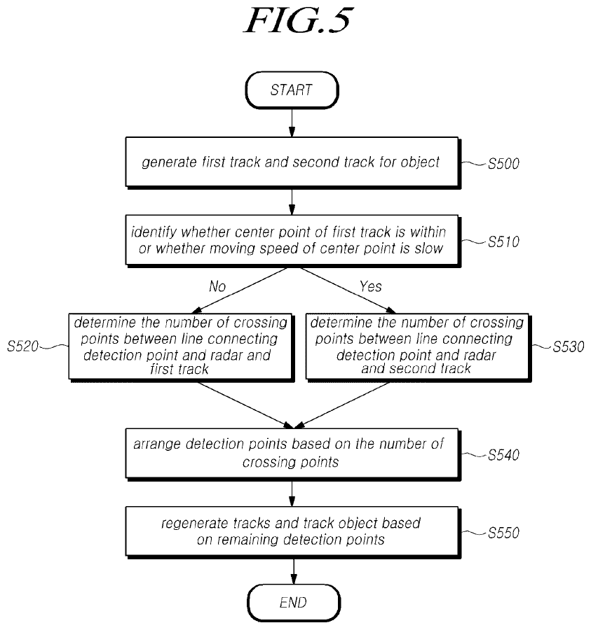

FIG. 5 is a flowchart illustrating a process of tracking an object using a center point of a track, according to an embodiment.

Referring to FIG. 5, an object tracking device of the disclosure performs the process of generating a track based on location information about a detection point received from a radar, and determining whether the detection point is a ghost based on movement information about the generated track to thereby track the object through a track regenerated based on an actual detection point.

The object tracking device of the disclosure generates a first track and a second track for an object around the host vehicle (S500).

The object around the vehicle may be a vehicle attempting to cut in toward the vehicle, a passerby passing in front of the vehicle, a person passing by a transportation other than a vehicle, or a stationary object.

The disclosure proposes a method for discerning whether the subject of the detection point obtained through signals transmitted/received by the radar is an object that is another vehicle attempting to cut in toward the host vehicle so that control of the host vehicle is required to avoid collision or an object irrelevant to driving of the host vehicle.

The object tracking device of the disclosure generates a first track including an object and a second track extended from the first track based on location information about a plurality of detection points obtained from a radar.

As described above, all of the plurality of detection points may be included in the first track, some may be included in the first track while some remaining detection points may be included between the first track and the second track, or some may be included in the second track while some remaining detection points may be included outside the second track.

The first track and the second track may be generated as two-dimensional figures based on an algorithm including at least one of an elliptic shape model, a random matrix model, or a random infinite set model. However, this is an example and may be generated in a three-dimensional form rather than a two-dimensional form.

For convenience of description, in the disclosure, an example in which the first track and the second track are elliptic shapes is described as an example.

If a track is generated, the object tracking device of the disclosure identifies whether the first track center point is within a set area or whether the moving speed of the center point is slow (S510).

The location of the center point of the first track may be set to the center location inside the track, or may be set to the location where the variance value of the distance from each point inside the track to each corner of the track is the smallest. However, this is merely an example, and the method for determining the center point is not limited thereto, and may be variously selected as necessary.

The object tracking device of the disclosure may obtain the location of the center point of the first track through the radar. Further, the object tracking device of the disclosure may obtain the moving speed of the center point of the first track through the radar, obtain moving speed information about each detection point from the radar, and determine the moving speed of the center point of the first track as the average value thereof.

The object tracking device of the disclosure identifies whether the location of the center point of the first track is within the set area. The set area is an area including at least one of a static object other than the object and a dynamic object other than the object, and the dynamic object may mean that the moving speed thereof is less than a set numerical value. In other words, the set area is an area with no or few moving objects, and means an area composed of objects with slow moving speed, such as a parking lot.

As another example, the object tracking device of the disclosure identifies whether the moving speed of the center point of the first track is less than the set first numerical value.

The result of determining whether the derived detection point is a ghost detection point that is excluded in the process of forming the track may be varied depending on the movement information including the location or moving speed of the center point of the first track.

When the center point of the first track is outside the set area or the moving speed of the center point of the first track is larger than or equal to the first numerical value, the object tracking device of the disclosure determines the number of crossing points between the line connecting the detection point and the radar and the first track (S520).

Alternatively, when the center point of the first track is within the set area or the moving speed of the center point of the first track is less than the first numerical value, the object tracking device of the disclosure determines the number of crossing points between the line connecting the detection point and the radar and the first track (S530).

If the number of crossing points is determined, the object tracking device of the disclosure determines whether the detection point is a ghost based on the number of crossing points, and arranges the detection points according to the determination result (S540).

For example, when the first track and the second track are set as elliptic shapes, the object tracking device of the disclosure may determine that the detection point is a ghost when there are two crossing points between a specific detection point and the track selected to be compared, and may determine that the detection point is an actual detection point when there are less than two crossing points or there are no two crossing points.

If determined as a ghost detection point, the detection point is excluded or removed from the track regeneration targets, and if determined as an actual detection point, the detection point is included in the track regeneration targets.

If the detection points are arranged, the object tracking device of the disclosure regenerates a track based on the remaining detection points and tracks the object (S550).

The object tracking device of the disclosure regenerates a track centered on the detection point except for the ghost detection point. The regenerated tracks may be a third track and a fourth track extended from the third track. In the disclosure, the third track may be referred to as a regenerated first track, and the fourth track may be referred to as a regenerated second track.

If the track regeneration is completed, the object tracking device may perform target tracking based on the regenerated track. The regenerated track may be subjected to a task for remodifying for each time period, and whether it is a track to be controlled to avoid collision with the host vehicle based on either the third track or the fourth track may be set variously as necessary.

The object tracking device of the disclosure may present a criterion for selecting only detection points of an object which disturb driving of the host vehicle among the detection points obtained from the radar when there are various objects and, when the moving speed of the object is significantly slow or the object approaches the host vehicle, form a track based only on the detection points selected based on the criterion, thereby making it possible to accurately perceive the object.

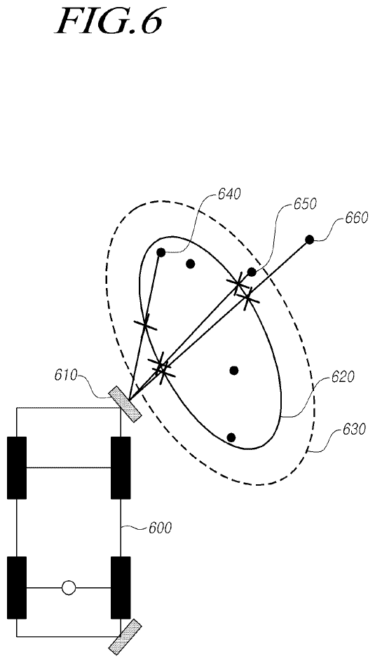

FIG. 6 is a view illustrating a usual-time object tracking method according to an embodiment.

Referring to FIG. 6, the object tracking device of the disclosure may determine an actual detection point and a ghost detection point based on the first track 620.

When the center point of the first track 620 is located outside the set area, the moving speed of the center point of the first track 620 is equal to or larger than the set first numerical value, or there is no set target to be compared with the movement information about the center point of the first track 620, the object tracking device of the disclosure determines the number of crossing points between the line connecting the radar 610 and the detection points and the first track 620.

The radar 610 mounted to the vehicle 600 may be located anywhere in the right front, left front, right rear, left rear, upper end, or lower end of the vehicle 600, and the number of radars is not limited to one, but radars may be installed in two or more vehicles as necessary.

If the location information about the detection point regarding the object is transferred from the radar 610 to the object tracking device, the object tracking device of the disclosure forms a first track 620 and a second track 630, and determines crossing points between the first track 620 and the line connecting the radar 610 and the detection point according to the movement information about the center point of the first track 620.

The detection point having two crossing points may be determined as a ghost detection point. Referring to FIG. 6, there are two detection points having two crossing points, and the detection points may be referred to as a first ghost detection point 650 and a second ghost detection point 660. The first ghost detection point 650 and the second ghost detection point 660 may not be objects as obstacles located around the vehicle 600, but may be detection points generated from objects that do not interfere with vehicle driving.

The detection point 640, in which the number of crossing points is not two, may be determined as an actual detection point.

The object tracking device of the disclosure regenerates a track based on the actual detection point 640 and performs object tracking.

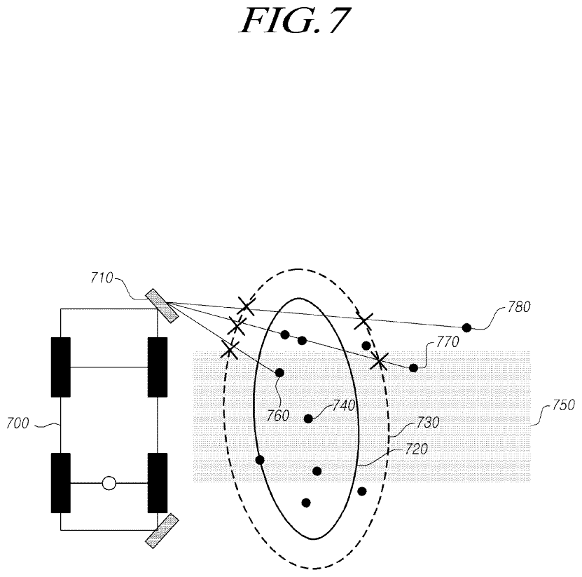

FIG. 7 is a view illustrating an object tracking method in a special situation, according to an embodiment.

Referring to FIG. 7, the object tracking device of the disclosure may determine whether the detection point is a ghost based on the second track 730.

When the center point 740 of the first track 720 is located within the set area 750 or the moving speed of the center point 740 of the first track 720 is less than the set first numerical value, the object tracking device of the disclosure determines the number of crossing points between the line connecting the radar 710 and the detection point and the second track 730.

As described above, the area 750 means an area including only stationary objects or objects having a significantly slow moving speed.

If the location information about the detection point regarding the object to be tracked is transferred from the radar 710 to the object tracking device, the object tracking device forms the first track 720 and the second track 730, and determines the number of crossing points between the second track 730 and the line connecting the radar 710 and the detection point according to the movement information about the center point 740 of the first track 720.

The detection point with two crossing points is determined as a ghost detection point. In the disclosure, the detection points are referred to as a first ghost detection point 770 and a second ghost detection point 780. The first ghost detection point 770 and the second ghost detection point 780 may not be objects as obstacles located around the vehicle 700, but may be unnecessary detection points from objects that do not interfere with vehicle driving.

The detection point 760, in which the number of crossing points is not two, is determined as an actual detection point.

The object tracking device of the disclosure regenerates a track based on the detection point determined as the actual detection point and performs object tracking.

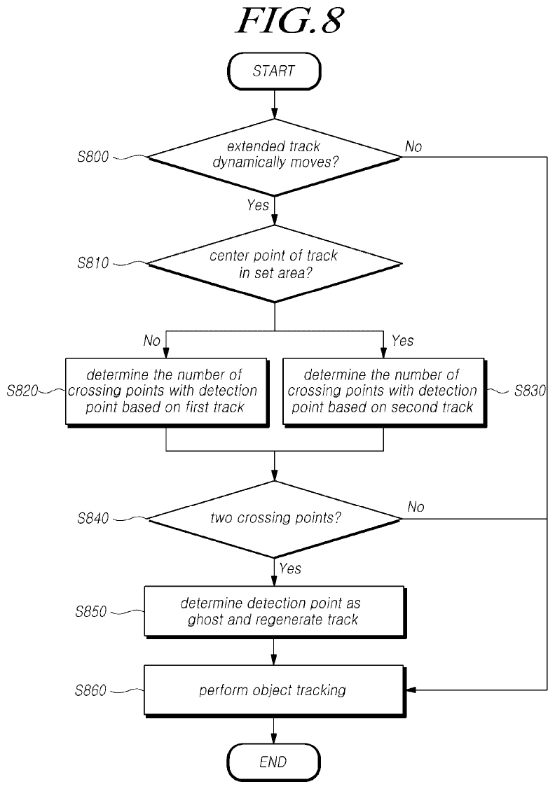

FIG. 8 is a flowchart illustrating an example of detecting an object based on a center point of a track, according to an embodiment.

Referring to FIG. 8, the object tracking device of the disclosure regenerates a track according to the location of the center point of the track, thereby tracking the object.

Specifically, the object tracking device of the disclosure generates a first track and a second track for an object around the host vehicle, and identifies whether the track moves dynamically (S800).

When the dynamic movement of the track is identified, the object tracking device of the disclosure identifies whether the location of the center point of the first track is inside the set area (S810).

When the center point of the first track is outside the set area, the object tracking device of the disclosure determines the number of crossing points between the line connecting the detection point and the radar and the first track (S820).

When the center point of the first track is within the set area, the object tracking device of the disclosure determines the number of crossing points between the line connecting the detection point and the radar and the second track (S830).

The object tracking device of the disclosure determines whether the number of crossing points determined based on either the first track or the second track is two (S840).

If the number of crossing points is two, the object tracking device of the disclosure determines the corresponding detection point as a ghost, and regenerates a track based on the detection point that is not determined as the ghost (S850).

The object tracking device of the disclosure performs object tracking based on the reproduced track (S860).

This process represents one of the methods for tracking an object according to the disclosure, and an object may be tracked in various ways according to the above description. Further, the order of the above-described steps is merely an example, and may be changed as necessary.

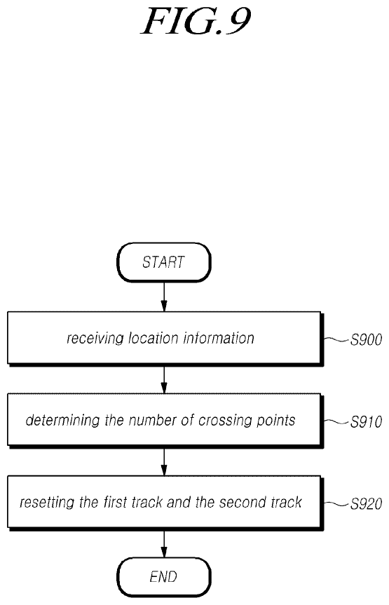

FIG. 9 is a flowchart illustrating a method for tracking an object using a center point of a track, according to an embodiment.

Referring to FIG. 9, a method for tracking an object using a center point of a track includes receiving location information about a plurality of detection points for the object from a radar, and setting a first track of the object and a second track extended from the first track based on the location information (S900).

By transmitting and receiving a signal through the object, the radar may derive location information including a direction and a distance in which a portion of the object is located based on a speed and a round trip time of the signal. In the disclosure, the portion of the object may be referred to as a detection point. Accordingly, the object tracking method of the disclosure may receive location information about a plurality of detection points for an object from a radar.

The object tracking device of the disclosure may set a first track based on the location information about the detection point received from the radar. The first track may be a two-dimensional figure including all of the received detection points. Alternatively, the first track may be a two-dimensional figure including some of the received detection points.

For example, when receiving three detection points from the radar, the object tracking device may set the first track including the three detection points. Alternatively, the object tracking device of the disclosure may set a first track including only two detection points among the three detection points received from the radar.

The shape of the first track may be a symmetrical figure such as of a triangle, a square, a circle, or an ellipse, or may be an asymmetric figure. Various shapes of the first track may be set as necessary, and the number of detection points is not limited.

The object tracking device of the disclosure may set a second track extended from the first track. For example, when the first track is an ellipse in which ½ of the long axis is 10 cm and ½ of the short axis is 5 cm, the second track may be an ellipse 5 cm longer than each of ½ of the long axis and ½ of the short axis of the first track. Alternatively, the second track may be an ellipse 5 cm longer than ½ of the long axis of the first track and 7 cm larger than ½ of the short axis. However, this is merely an example, and the shape of the second track may not be the same as that of the first track. Various shapes of each track may be set as necessary.

For example, the object tracking device of the disclosure may set the first track and the second track in an elliptical shape. Since the object tracking device of the disclosure needs to clearly identify the location and shape of another vehicle to avoid collision with the other vehicle attempting to cut in while the host vehicle moves, it is proposed that the first track and the second track have an ellipse which is a shape most similar to that of the vehicle. However, this is merely an example, and various shapes may beset as necessary, such as a circular shape, a square shape, a triangle, etc.

As another example, the object tracking device of the disclosure may set the first track and the second track based on an algorithm including at least one of a random finite set model, a random matrix model, or an elliptic shape model.

An extended object tracking method according to the disclosure has been developed to compensate for the issues with the conventional object tracking method in of tracking the target with a single point taken as the target, and the extended object tracking method is a method for tracking an object using a plurality of detection points.

For example, the object tracking device of the disclosure may use an algorithm including at least one of a random finite set model, a random matrix model, or an elliptic shape model in forming a track based on location information about a plurality of detection points. The disclosure proposes to use an algorithm including an elliptic shape model for tracking an object by forming a track having a shape similar to the shape of a vehicle to prevent collision with another vehicle approaching the host vehicle.

The object tracking method using the center point of the track includes determining the number of crossing points of the line connecting the detection point and the radar and any one of the first rack or the second track based on movement information about the center point of the first track (S910).

The object tracking device of the disclosure may find and remove a ghost detection point other than the detection point regarding the actual object in the location information about the plurality of detection points received from the radar in order to track the object around the vehicle without an error.

The above-described ghost detection point may refer to a detection point generated due to a radar signal error for an object approaching at a low speed from a location close to the host vehicle, or a detection point generated from another object located around the object.

In the disclosure, the ghost detection point may also be referred to as a ghost.

As a method for removing the ghost detection point, there is proposed a method in which the object tracking device of the disclosure determines the number of crossing points between the line connecting the detection point and the radar and any one of the set first track or the second track, and if the determined number of crossing points is larger than or equal to a predetermined number, determines and removes the corresponding detection point as a ghost.

Which of the first track or the second track is a reference to determine the number of crossing points may be determined based on the movement information about the first track center point.

For example, in the object tracking device of the disclosure, the movement information about the first track center point may be determined based on the location information about the detection point, and may include at least one of the location and the moving speed of the first track center point.

As another example, when the location of the first track center point is located outside the set area, the object tracking device of the disclosure may determine the number of crossing points between the line connecting the detection point and the radar and the first track.

As another example, when the location of the first track center point is located in a set area, the object tracking device of the disclosure may determine the number of crossing points between the line connecting the detection point and the radar and the second track.

In order to remove the ghost detection point, the object tracking device of the disclosure may determine the number of crossing points between the first track or the second track and the line connecting the radar and the detection point, compare the determined number of crossing points with a predetermined number, determine whether the detection point is a ghost detection point which is a ghost based on the comparison result, and remove the detection point when the corresponding detection point is determined as the ghost detection point.

As another example, the inside of the set area may include at least one of the object tracked by the object tracking device, a static object other than the object, and a dynamic object other than the object, and the moving speed of the dynamic object may be less than a first numerical value.

The ghost detection point to be removed by the object tracking device of the disclosure may be generated when the distance between the host vehicle and the object is short, or an object having a slow moving speed approaches the host vehicle. Accordingly, the object tracking device of the disclosure may set an area including objects with little movement in real time, and when the center point of the first track is located in a predetermined area, set the size of the object to be larger and determine the number of crossing points between the second target extended from the first target and the line connecting the radar and the detection point.

When the center point of the first track is located outside the set area, the number of crossing points between the first track and the line connecting the radar and the detection point is determined.

As another example, when the moving speed of the first track center point is less than a second numerical value, the object tracking device of the disclosure may determine the number of crossing points between the line connecting the detection point and the radar and the second track.

As another example, when the moving speed of the first track center point is larger than or equal to the second numerical value, the object tracking device of the disclosure may determine the number of crossing points between the line connecting the detection point and the radar and the first track.

In light that many ghost detection points may be generated when the moving speed of the target is slow, the object tracking device of the disclosure may determine the number of crossing points between the line connecting the detection point and the radar and the second track when the moving speed of the first track center point is less than the set second numerical value, and determine the number of crossing points between the line connecting the detection point and the radar and the first track when the moving speed of the first track center point is larger than or equal to the set second numerical value, thereby removing the ghost detection point.

The object tracking method of the disclosure includes resetting a first track and a second track based on location information about detection points where the number of crossing points is less than a preset number, N (where N is an integer larger than or equal to 2), and track an object based on any one of the reset first track or second track (S920).

When the number of crossing points is larger than or equal to the preset number N (where N is an integer larger than or equal to 2), the object tracking device of the disclosure may determine that the corresponding detection point is a ghost detection point irrelevant to the object, and set the first track and the second track again around the remaining detection points after removing the detection point determined as the ghost detection point, thereby tracking the target in real time.

The determination criterion for the ghost detection point may be when the number of crossing points is N or more, or when the number of crossing points is N. As the above-described determination criterion is merely an example, various determination criteria may be set as necessary.

Through the operations of the above-described steps, it is possible to accurately detect an object and accurately determine the likelihood of collision between the host vehicle and the object to thereby safely performing vehicle control through ADAS or autonomous driving.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

1. An object tracking device, comprising:
a track setter receiving location information about a plurality of detection points for an object from a radar and setting a first track of the object and a second track extended from the first track based on the location information;
a crossing point counter determining the number of crossing points between a line connecting the detection point and the radar and any one of the first track or the second track based on movement information about a first track center point; and
an object tracker resetting the first track and the second track based on location information about a detection point in which the number of crossing points is less than N as preset (where N is an integer of two or more) and tracking the object based on any one of the reset first track or second track.

2. The object tracking device of claim 1, wherein the track setter sets the first track and the second track as an elliptic shape.

3. The object tracking device of claim 1, wherein the track setter sets the first track and the second track based on an algorithm including at least one of a random finite set model, a random matrix model, and an elliptic shape model.

4. The object tracking device of claim 1, wherein the movement information about the first track center point is determined based on the location information about the detection point, and includes at least one of a location and moving speed of the first track center point.

5. The object tracking device of claim 4, wherein the crossing point counter determines the number of crossing points between the line connecting the detection point and the radar and the first track when the location of the first track center point is outside a set area.

6. The object tracking device of claim 5, wherein the crossing point counter determines the number of crossing points between the line connecting the detection point and the radar and the second track when the location of the first track center point is inside the set area.

7. The object tracking device of claim 6, wherein an inside of the set area includes at least one of the object, a stationary object other than the object, and a dynamic object other than the object, and
wherein a moving speed of the dynamic object is less than a first numerical value.

8. The object tracking device of claim 4, wherein the crossing point counter determines the number of crossing points between the line connecting the detection point and the radar and the first track when the moving speed of the first track center point is less than a second numerical value.

9. The object tracking device of claim 4, wherein the crossing point counter determines the number of crossing points between the line connecting the detection point and the radar and the second track when the moving speed of the second track center point is a second numerical value or more.

10. An object tracking method, comprising:
receiving location information about a plurality of detection points for an object from a radar, and setting a first track of the object and a second track extended from the first track based on the location information;
determining the number of crossing points between a line connecting the detection point and the radar and any one of the first track or the second track based on movement information about a first track center point; and
resetting the first track and the second track based on location information about a detection point in which the number of crossing points is less than N as preset (where N is an integer of two or more), and tracking the object based on any one of the reset first track or second track.

11. The object tracking method of claim 10, wherein setting the first track and the second track sets the first track and the second track as an elliptic shape.

12. The object tracking method of claim 10, wherein setting the first track and the second track sets the first track and the second track based on an algorithm including at least one of a random finite set model, a random matrix model, and an elliptic shape model.

13. The object tracking method of claim 10, wherein the movement information about the first track center point is determined based on the location information about the detection point, and includes at least one of a location and moving speed of the first track center point.

14. The object tracking method of claim 13, wherein determining the number of crossing points determines the number of crossing points between the line connecting the detection point and the radar and the first track when the location of the first track center point is outside a set area.

15. The object tracking method of claim 14, wherein determining the number of crossing points determines the number of crossing points between the line connecting the detection point and the radar and the second track when the location of the second track center point is outside a set area.

16. The object tracking method of claim 15, wherein an inside of the set area includes at least one of the object, a stationary object other than the object, and a dynamic object other than the object, and
wherein a moving speed of the dynamic object is less than a first numerical value.

17. The object tracking method of claim 13, wherein determining the number of crossing points determines the number of crossing points between the line connecting the detection point and the radar and the first track when the moving speed of the first track center point is a second numerical value or more.

18. The object tracking method of claim 13, wherein determining the number of crossing points determines the number of crossing points between the line connecting the detection point and the radar and the second track when the moving speed of the second track center point is a second numerical value or more.
